(19) United States
(12) Patent Application Publication
(10) Pub. No.: US 2006/0152019 A1
(43) Pub. Date: Jul. 13, 2006

(54) Door stop and holder

(76) Inventor: George Depasquale, Hartford, CT (US)

Correspondence Address: TED PAULDING, 10 PENWOOD LA., WETHERSFIELD, CT, 06109, US

(21) Appl. No.: 11/032,476

(22) Filed: Jan. 10, 2005

(51) Int. Cl. E05C 19/16

(52) U.S. Cl. 292/251.5

(57) ABSTRACT

A door stop and holder has a magnet mounted on a door and a metallic disc mounted on the end of a coil spring which projects from a wall. Both the magnet and the disc are adapted for slight free movement for self alignment and enhanced grasping and long term holding action by the magnet.

### BACKGROUND OF THE INVENTION

Door stops are of course common in every residential, commercial and institutional building. Holding devices for securing doors in the open position are, on the other hand, quite rare and represent an unfulfilled need. The housewife with arms full of groceries and with the kitchen door repeatedly bouncing back and hitting her would certainly welcome something to hold the door in the open position. Similarly, the owner of a beach house with the ocean breeze continually swinging an open door and bouncing it off the door stop, would welcome the opportunity for a quiet nap. Widespread commercial and institutional use is also anticipated. It is the general object of the present invention to provide a simple inexpensive device which provides an automatic grasping and holding function and which inherently, in the absence of other door stopping means, also provides a door stopping function.

### SUMMARY OF THE INVENTION

In accordance with the present invention, and in fulfillment of the foregoing object, a combined door stop and holder is provided in the form of a pair of operative elements one of which is magnetic and the other of which is attracted thereto. Mounting means is provided for securing one of the elements on a door and means for mounting the other element is secured to a vertical surface such as a wall adjacent the door. At least one of the elements is held by its mounting means for slight free movement to provide a self alignment feature for the two elements and thus enhance the initial grasping and long term holding action of the magnet.

In providing the required slight free movement, the magnet may be adapted to provide a rocking motion and/or the element attracted to the magnet may be adapted for slight universal movement as for example by mounting the element on the free end of a somewhat elongated coil spring. Finally, the resilient or cushioning action of a conventional door stop may be duplicated by incorporating a small resilient elastomeric member behind the element which is attracted to the magnet.

### DESCRIPTION OF THE DRAWINGS

FIG. 1 is a perspective view of the element attracted to the magnet which forms a part of the door stop and holder of the invention,

FIG. 2 is an exploded side view of the element of FIG. 1,

FIG. 3 is a side view of the magnet of the invention and its housing,

FIG. 4 is a front view of the magnet and housing,

FIG. 5 is a sectional view of a head portion of the element attracted to the magnet showing an alternative embodiment of the invention.

### DESCRIPTION OF THE PREFFERED EMBODIMENTS

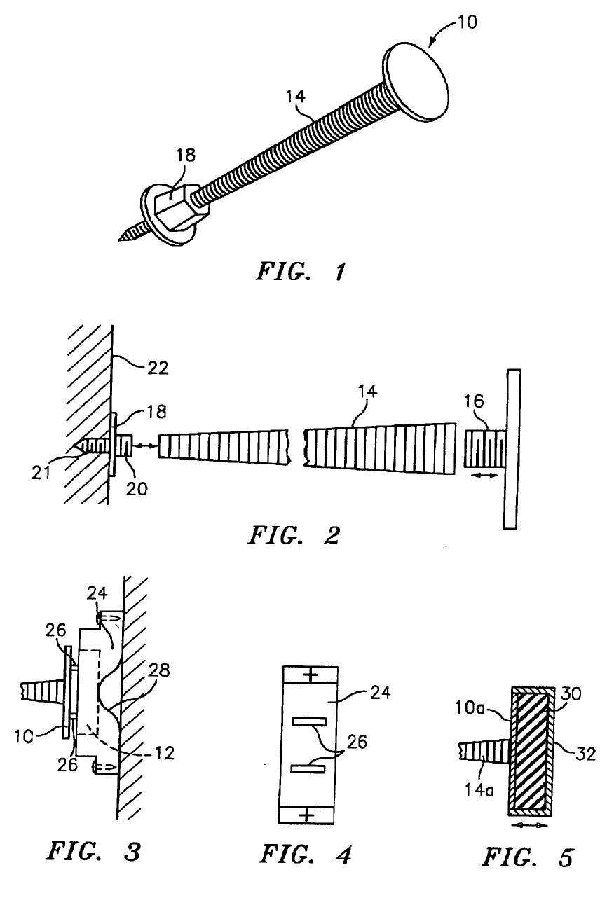

Referring particularly to FIG. 1, one element of the invention is illustrated generally at 10 and in FIG. 3, the element 10 is shown in co-operative relationship with the other element, more particularly, a magnet 12. The element 10 may vary widely but preferably takes the form of a steel or other metallic disc which is attracted to the magnet 12. A mounting means for the disc 10 preferably comprises a somewhat elongated coil spring 14 of the type found in conventional door stops. A boss 16 on the rear surface of the disc 10 may be threaded for retention into the open free end of the spring 14, adhesively secured in the spring open end, or retained therein in a press fit.

At an opposite end the spring 14 is secured to a wall mounting means in the form of a base member 18 which has a small boss 20 for entry into the base end of the coil spring. Retention of the boss within the spring end may be accomplished by any of the foregoing means. On a side opposite the boss, the base member 18 carries a small screw 21 or other means for attachment to a vertical surface such as a wall 22.

As will apparent, when mounted on a wall or other surface, the coil spring 14 will accommodate slight universal movement at its free end for enhanced grasping and holding efficiency of the magnet 12 as aforesaid. The magnet 12, preferably ceramic, may vary widely. As shown, it is enveloped in a small plastic housing 24 and has two small protruding bars 26, 26 which may represent poles of the magnet and which engage the disc 10 in fulfilling the grasping and holding function of the device. Preferably the magnet 12 is mounted within its housing 24 for slight rocking movement as might be provided by a small leaf spring 28. This assists in establishing good contact between the disc 10 and the bars 26, 26 for enhanced grasping and holding action.

Finally, in FIG. 5 an alternative embodiment of the invention provides improved resiliency in the direction of engagement of the magnet and its cooperating element 10a. That is, the coil spring provides some resiliency in this direction but more may be desired, This can readily be accomplished by incorporating a small elastomeric disc 30 and adhesively securing the same to the disc 10a. The magnet must of course have sufficient force for this arrangement. Still further, a metallic cap 32 may be provided and secured in a sliding arrangement over the elastomeric disc 30 for wear resistance.

1. A door stop and holder comprising a pair of operative elements one of which is magnetic and the other of which is attracted thereto, means for mounting one of the elements on a door surface and means for mounting the other of the elements on an adjacent generally vertical surface, at least one of the elements being held by its mounting means for slight free movement so as to provide a self alignment feature for the two elements and thus enhance the initial grasping and long term holding action of the magnet.

2. A door stop and holder as set forth in claim 1 wherein the magnet is adapted to provide a free rocking motion for assistance in the grasping and holding action.

3. A door stop and holder as set forth in claim 1 wherein the mounting means for the element attracted to the magnet provides for slight but substantially universal movement for assistance in the grasping and holding action of the magnet.

4. A door stop and holder as set forth in claim 2 and including the features of claim 3.

5. A door stop and holder as set forth in claim 2 wherein the magnet has two small parallel projecting bars which are mounted for relative rocking movement toward and away from the element attracted thereto.

6. A door stop and holder as set forth in claim 6 wherein the element attracted to the magnet is mounted on the vertical surface.

7. A door stop and holder as set forth in claim 3 wherein the mounting means includes a spring projecting from the vertical surface and mounting the element attracted to the magnet for slight but substantially universal alignment movement.

8. A door stop and holder as set forth in claim 7 wherein a coil spring is employed with an open end for mounting the element attracted to the magnet, and wherein said element takes the form of a metallic member in a disk-like shape for engaging the magnet and has a small boss projecting into and retained in the open end of the spring.

9. A door stop and holder as set forth in claim 8 wherein the boss is adhesively retained in the end of the coil spring.

10. A door stop and holder as set forth in claim 9 wherein the boss is frictionally held in the end of the coil spring in a press fit.

11. A door stop and holder as set forth in claim 8 wherein a base member is provided and is secured to the vertical surface, said member also including a small boss which is entered and retained in an end of the coil spring opposite the metallic member.

12. A door stop and holder as set forth in claim 1 wherein a small resilient member is secured to the element attracted to the magnet.

13. A door stop and holder as set forth in claim 12 wherein a small metallic cap is secured to the resilient member for sliding action relative to the element attracted to the magnet.
